(19) United States
(12) Patent Application Publication
(10) Pub. No.: US 2016/0134694 A1
(43) Pub. Date: May 12, 2016

(54) CONTENT DELIVERY NETWORK BASED NETWORK LATENCY REDUCTION APPARATUS, METHODS AND SYSTEMS

(71) Applicant: StartApp, Inc., New York, NY (US)

(72) Inventors: Michael Berdichevsky, Kfar Saba (IL); Guy Sheffer, Ra'anana (IL); Ran Avidan, Zikhron Ya'akov (IL)

(21) Appl. No.: 14/935,150

(22) Filed: Nov. 6, 2015

Related U.S. Application Data
(60) Provisional application No. 62/076,904, filed on Nov. 7, 2014.

(51) Int. Cl. H04L 29/08; H04L 12/911

(52) U.S. Cl. CPC H04L 67/1095; H04L 67/06; H04L 67/18; H04L 47/70

(57) ABSTRACT

Some embodiments relate to a method of defining a first pointer file containing a first location identifier for a content located at a Content Delivery Network (CDN) server so as to cause placement of the first pointer file at the CDN server. Further, the method includes the step of receiving, from a requesting device, a request for the content, the request including data on at least one of the requesting device or a user of the requesting device. In addition, the method allows for constructing a second location identifier containing at least one element derived from the data, and sending a second pointer file containing the second location identifier to the requesting device, where the second location identifier matching the first location identifier when a software development kit (SDK) executing on the requesting device defines the at least one element.

### CROSS-REFERENCE TO RELATED APPLICATIONS

This application claims benefit of and priority under 35 USC §119 to U.S. Provisional Patent Application Ser. No. 62/076,904 filed Nov. 7, 2014, entitled “User Implemented Content Provision Apparatuses, Methods and Systems,” the entire contents of which is incorporated by reference herein in its entirety.

### FIELD

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

Some embodiments relate to the provision of large blocks of data or content to a requesting device over a multi-computer data transferring network. To reduce network latency, the contents may be procured from content delivery network (CDN) servers that include instances of the contents found in content generator servers. The provision of the contents is facilitated by integration of a software development kit (SDK) in a user device for communicating with the content generator servers and/or the CDNs.

### BACKGROUND

Web pages typically are written in HTML (hypertext markup language) and are translated into viewable display by a Web browser. HTML code can be provided by a web server, such that when the HTML code is received at a user's browser, the browser translates the HTML code to display the web page. Static web pages show the same content each time the pages are accessed.

### BRIEF DESCRIPTION OF THE DRAWINGS

FIG. 1 shows a block diagram illustrating aspects of embodiments of the present disclosure.

FIG. 2 shows an example data flow illustrating aspects of CDN-based user-implemented content provision, in one embodiment;

FIG. 3 shows an example logic flow illustrating aspects of determining, at a content generator server, content location pointers, in one embodiment; and

FIGS. 4A-B show an example logic flow illustrating aspects of determining, at a user device, content location pointers, in one embodiment.

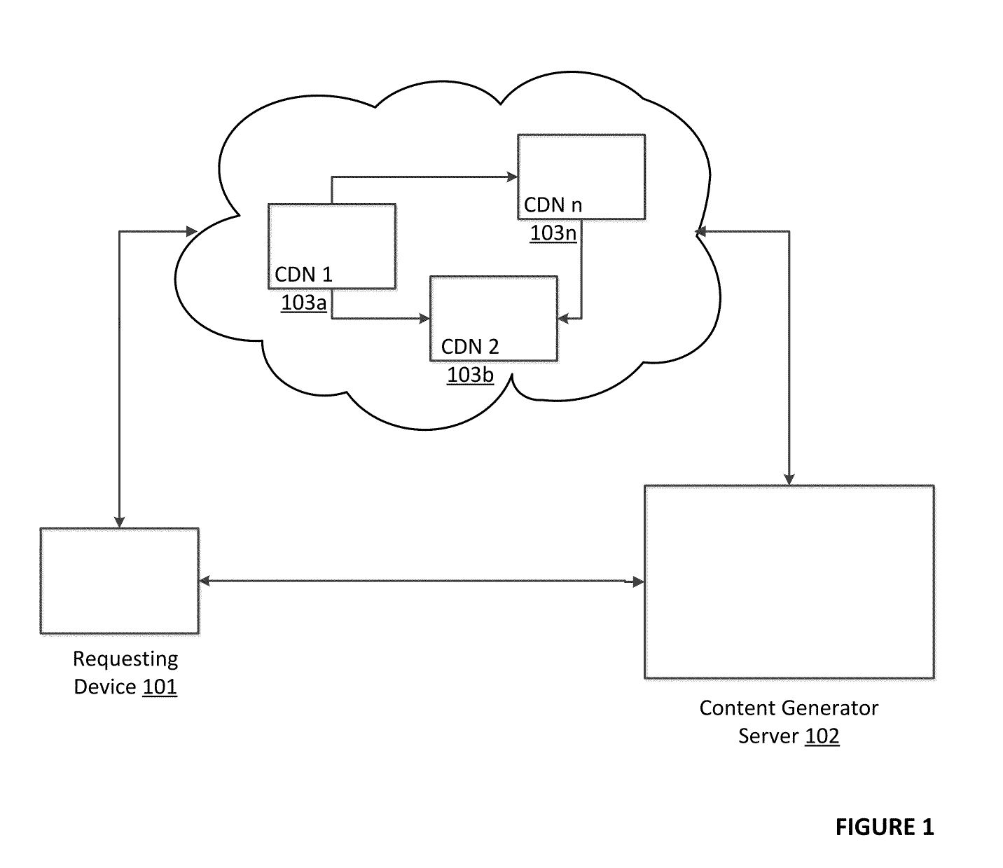

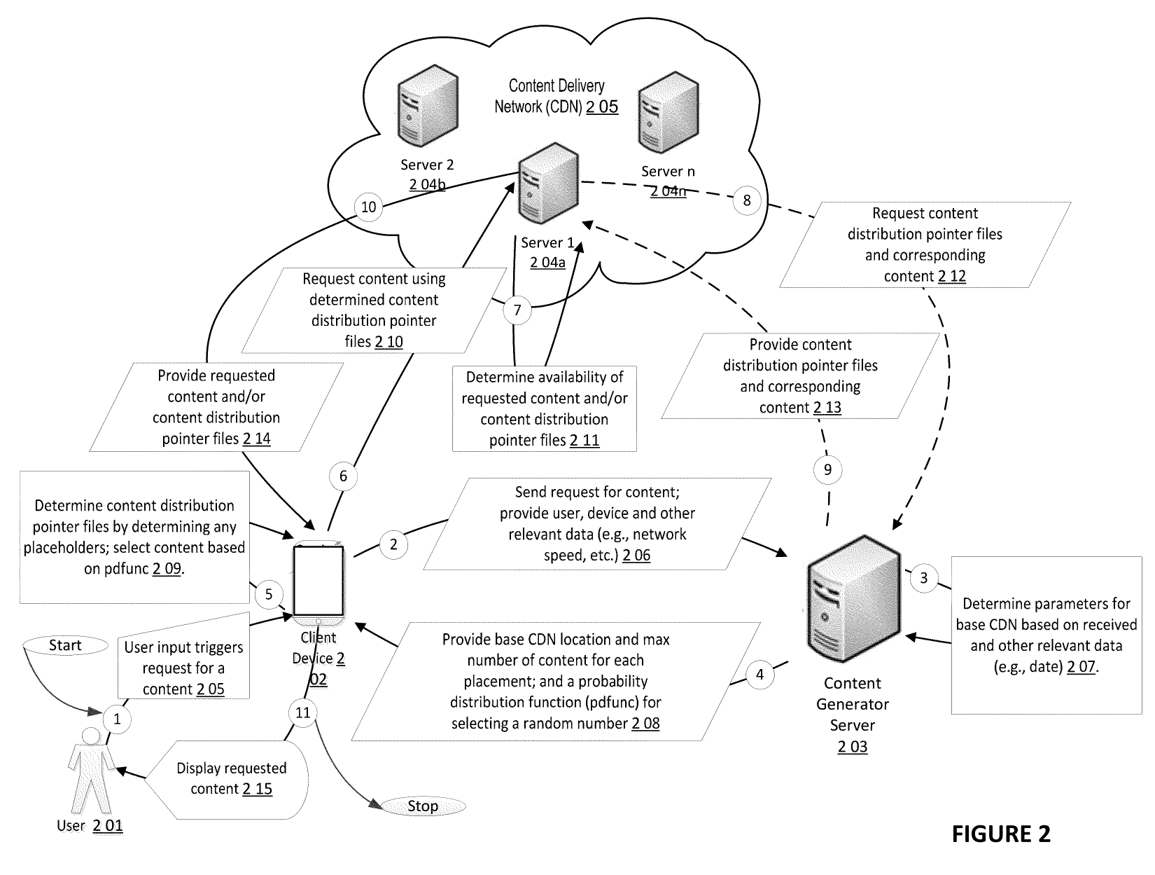

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2A, 2B, etc.

### SUMMARY OF THE EMBODIMENTS

Some embodiments of the present disclosure relate to a method of defining a first pointer file containing a first location identifier for a content located at a Content Delivery Network (CDN) server so as to cause placement of the first pointer file at the CDN server. Further, the method includes the step of receiving, from a requesting device, a request for the content, the request including data on at least one of the requesting device or a user of the requesting device. In addition, the method allows for constructing a second location identifier containing at least one element derived from the data, and sending a second pointer file containing the second location identifier to the requesting device, where the second location identifier matching the first location identifier when a software development kit (SDK) executing on the requesting device defines the at least one element.

### DETAILED DESCRIPTION

Some embodiments of the present disclosure discuss the transformation of user device content request input into outputs of content location pointers and content files. When serving content where the timing of its delivery is important (e.g., content is time-sensitive such as advertisement campaigns) or the timing is constrained (e.g., requester is at a large distance away from content generator), one may wish to keep the network latency between the request and/or the decision to serve the content and the actual delivery of the content to a minimum. In some instances, this may mean reducing the distance (e.g., physical and/or time) between the user or requesting device 101 and the content generator server 102 as much as possible. For example, for advertisement campaigns, reducing network latency may involve large distribution of the ad server instances to reduce the distance between the user's device and the ad server. Another technique for reducing network latency when delivering content, in particular when delivering large-sized files and/or delivering over congested data transfer lines, is the usage of content delivery networks (CDNs) 103. Using the example of advertisement campaigns, the HTML pointer files can represent the campaigns, and include links to the campaign's static creative content such as images, videos files, audio files, etc. In general, in addition to static creative content, HTML pointer files may also include links to formatting files (e.g., cascading style sheets (CSS), java script files, etc.). In such embodiments, the HTML pointer files may be served from the content generator (e.g., an ad server) and may be chosen dynamically for each content request according to many targeting, filtering and/or optimization rules.

In some embodiments, the delivery of content may comprise two steps, the transmission of an HTML pointer file by the content generator to the requesting device 101 and the fetching of static files, which may be large-sized, from the content generator server 102 and/or CDN servers 103 for delivery to the requesting device. An example block diagram of the components used in such embodiments is shown in FIG. 1. In some instances, the utilization of CDN servers 103 for delivering the content files may reduce the distance between the requesting device and the static content files. Where content may be time sensitive and may change rather quickly (e.g., timed advertisement campaigns), it may be desirable to use a CDN server 103a-n for the HTML pointers that may be dynamically adapted to various campaigns as well. Thus one may reduce the latency due to the sending of an HTML pointer file by using CDN servers in this manner.

For example, a content generating server 102 such as an ad server may define a static HTML pointer file per campaign, store the HTML pointer file in the CDN servers under folders representing the content delivery rules (e.g., the advertisement campaign's targeting rules according to some pre-defined schema) and name the files containing the creative content with an ordinal number. In such embodiments, the CDN may replicate the files to some or all of the CDN servers 103 in its private network to facilitate the reduction of network latency. Further, the relevant creative files may be updated periodically and/or as needed at the CDN servers via communication with the content generator server (e.g., via a scheduled automatic process). The content delivery rules may include rules on the prioritization of content delivery (e.g., the priority of the campaigns, etc.), the targeting or filtering of the delivery (e.g., based on the recipient, timing, location, campaign audience, etc.), the limitations or requirements of the content delivery (e.g., campaign's daily and/or user impression caps, etc.), and/or the like. In some instances, the CDN servers and the content generating server may communicate regularly so as to enforce the limitations and/or requirements (e.g., caps), and as mentioned above, to allow updates of the data residing at the CDN servers with those at the generating server.

FIG. 2 is an example data flow illustrating aspects of CDN-based content provision, in one embodiment. In one embodiment, user 201 initiates a session by launching an application on a user device, 202. The user device may be a mobile device, for example, any of an iPhone, smart phone, iPad, tablet, Android phone, personal laptop computer, and/or the like. In some embodiments, an SDK may be integrated into the application source code, and at launch the application can load into memory and execute stored program commands corresponding to some or all of the SDK operations. For example, the application may communicate with a content generating server 203 and/or CDN servers 204 to procure content from the content generator server 203 and/or CDN servers 204 and display the content at the user device 202.

Upon session initialization by the user 201, user device 202 may send a content request 206 to the content generator server 203 such as ad server. For example, an SDK integrated in an application at the user device may provide the content generator server 203 with some or all relevant data and/or parameters used for serving the content, such data and/or parameters including one or more of device data, demographic data, user behavior data, user preferences, etc. Non-limiting examples of such relevant data and/or parameters are make and model of the device, an identifier of the operating system running on the device, data on user's gender, age, social status, user income level, user recreational activities, and user social status, etc.; user's application usage data; user's profile, and/or the like. In some embodiments, the relevant data and/or parameters may be static or dynamic. For the dynamic cases, in some instances, the SDK may provide the content generator server targeting fields that would eventually be populated by the SDK. Further, the SDK may provide the content generator server data on the macros the SDK supports, and the manipulations that can be applied to the dynamic fields, such as but not limited to trimming, formatting, transforming, encoding, etc. An example content request 206, substantially in the form of an HTTP(S) POST message including XML-formatted data, is provided below:

POST /request_content_content.php HTTP/1.1
Host: www.contentserver.com
Content-Type: Application/XML
Content-Length: 667
<?XML version = ″1.0″ encoding = ″UTF-8″?>
<content_request>

<timestamp>2020-12-12 15:22:43</timestamp>
<user_name>John Doe</user_name>
<!- user initiates session by launching app with contents in

it −>

<app_name>Free Game App</app_name>
<app_id>2356</app_id>
<app_credentials>

<public_key>sdfaj323njk3543frff</public_key>

</app_credentials>
<!- data/parameters related to the device user −>
<user_data>

<user_profile type=”demographic” />

<user_gender=”male” />
<user_age =”tier 2” /> // 35-49yo
<user_income =”tier 3” /> // 100K-150K

<user_profile type=”behavior” />

<interest_levsls> // lowest=0; highest =10

<games=1 />
<music=8>

<genre_1 = ”rock” />
<genre_2 = ”house” />

</music>
<movies=4 />
...

</interest_levels>
<app_usage_level=”high” />

</user_data>
<!- data/parameters related to the user device −>
<device_data>

<device_requesting type=”android_phone”>

<capability type=”java” version=” jdk1.1” />
<capability type=”flash” version=”5.43” />
<capability type=”voice_recording” />
<capability type=”camera” resolution=”9MP” />
<capability type=”GPS” precision=”3ft” />

</device_requesting>

</device_data>
<!- Info related to dynamics fields to be populated by user

device −>

<dynamic_fields_data>

<dynamic_field type=”network” />

<network type=”wifi”/>

<network speed=”high”/>
//<network speed=”med”/>
//<network speed=”low”/>

<dynamic_field type=”placement” />

<placement type=”banner” />
//<placement type=”app-wall” />
//<placement type=”full screen” />

...

</dynamic_fields_data>

</content_request>

At 207, the content generator server 203 can then determine the CDN location from where the user device may access relevant contents, based on the provided data and/or parameters. In determining which contents are relevant, in some embodiments, the content generator server 203 may optionally perform several computations and/or apply some complicated logic, with the goal of providing preferred content (e.g., choosing a fitting advertisement campaign for a specific user by targeting the specific user according to some user-specific criteria and/or enforcing caps and limits, such criteria depending on the above-noted relevant data and/or parameters, for example). The content generator server 203 may construct a complete or incomplete CDN address pointer to a CDN server where the base location of the CDN pointer indicates the location at which the contents relevant for the user's session reside. In some embodiments, the location pointer may include several types of elements, some non-limiting examples being static and dynamic elements. Static elements are parameters that may be extracted by the SDK and passed on to the content generator server in the request, and/or were resolved by the content generator server according to other parameters. Examples are known data about the user and/or device, such as country, age, gender, device type, categories preferences, etc. Such static elements, in some instances, may be known by the content generator server while constructing CDN location pointers. Dynamic elements may not be known and/or may be determined by the content generator server when constructing the location pointer, and the content generator server may utilize placeholders in constructing the pointers. Examples are characteristics related to current user, device, environment, etc., such as but not limited to current physical location of the device, current activity in the app, instantaneous time when the content is ultimately displayed to the user, current temperature/weather conditions, current speed/velocity if the user/device is traveling, etc. The placeholders that are used to represent dynamic elements by the content generator server in constructing the location pointer may be replaced by their real values during retrieval of the contents by the user device. In some embodiments, the content generator server may use placeholder for static elements as well.

An example of a structure of a (not-necessarily complete) base CDN location pointer comprising static and dynamic elements is provided below:

http://cdn.startapp.com/creatives/android/{PLACEMENT_PLACEHOLDER}
/US/en_US/Male/{NETWORK_TYPE_PLACEHOLDER}/

In this example, a portion of the base CDN location pointer, http://cdn.startapp.com/creatives/, indicates the base location where the relevant content files may be residing at or stored. This example base CDN location is constructed or defined based on parameters related to the requesting device (e.g., user device 202) and/or the user and other data. For example, the static element android indicates the type of the requesting device while the static element Male refers to the gender of the device user. Placeholders such as {PLACEMENT_PLACEHOLDER} and {NETWORK_TYPE_PLACEHOLDE} represent dynamic variables that may be determined and populated (i.e., replaced by real values) by the user device 202 in requesting for the contents from the CDN servers. In this example, placeholders {PLACEMENT_PLACEHOLDER} and {NETWORK_TYPE_PLACEHOLDE} represent the placement of the content on the user device display and the network type the user device is connected to, respectively. In some embodiments, some elements may be treated either as a static or dynamic, or both. For example, physical location may be represented by US/NY/{DEVICE_CITY}, which includes both static and dynamic elements. As another example, and as will be discussed below, if the user device requesting for an ad content is connected to a Wi-Fi™ network and it is desired a full screen ad is to be served to the user, the user device may replace the placeholders with keywords (e.g., wifi, cellular, etc., for network type and full_screeen, banner, etc., for placement) to arrive at a base CDN location pointer as provided below:

http://cdn.startapp.com/creatives/android/full_screen/US/en_US/Ma
le/wifi/

At a base CDN location such as the preceding one, more than one content may optionally be present, and the user device 202 may have a way to choose one or more of these contents to display. In some embodiments, the content generator server may also provide to the user device 202 a probability distribution function (PDFunc) that may be utilized by the SDK in choosing a content. For example, for some maximum index of content files in a location given by a pointer, the content generator server may provide a PDFunc that selects a content according to a weight (i.e., priority). For example, the location at the above path may have 3 ads (A, B and C), so the PDFunc may be expressed as {A: 0.2, B: 0.5, C: 0.3}, indicating that ad A has a probability of 0.2, ad B has a probability of 0.5 and ad C has a probability of 0.3 in being chosen for display.

In response to the request from the user device 202, the content generator server 203 may send a content response 208 to the user device. An example content response 208, comprising base CDN location pointers and PDFuncs, substantially in the form of an HTTP(S) POST message including XML-formatted data, is provided below:

POST /response_content_content.php HTTP/1.1
Host: www.user.com
Content-Type: Application/XML
Content-Length: 667
<?XML version = ”1.0” encoding = ”UTF-8”?>
<content_response>

<timestamp>2020-12-12 18:22:43</timestamp>
<!- base cdn structure including placeholders −>
<base_cdn_struct>

http://cdn.startapp.com/creatives/android/{PLACEMENT_PLACEHOLDER
/US/en_US/Male/{NETWORK_TYPE_PLACEHOLDER} </base_cdn_struct>

<!- PDFUNCs for the different permutations of placeholders −>
<PDFUNCs>

<PLACEMENT_PLACEHOLDER==banner and

NETWORK_TYPE_PLACEHOLDER==wifi, PDFunc=”{0.35 0.25 0.3 0.1}” />

<PLACEMENT_PLACEHOLDER== full_screen and

NETWORK_TYPE_PLACEHOLDER==wifi, PDFunc=”{0.25 0.6 0.15}” />

<PLACEMENT_PLACEHOLDER==banner and

NETWORK_TYPE_PLACEHOLDER==cellular, PDFunc=”{1}” />

<PLACEMENT_PLACEHOLDER== full_screen and

NETWORK_TYPE_PLACEHOLDER==cellular, PDFunc=”{0.25 0.15 0.15 0.2
0.2 0.05}” />

</PDFUNCs>

</content_response>

Upon receiving the response from the content generator server 203, in some embodiments, the SDK may populate the placeholders with the keywords as discussed above by performing the pre-defined actions/manipulations at 209. In some instances, the manipulations may be in the form of trimming, formatting, transforming, encoding, etc. Further, the SDK may draw a number up to the maximum index for each CDN location pointer according to the PDFunc, and select a content based on the drawn number to be displayed at the user device 202. As an example, the CDN location pointer after the replacement of the dynamic elements with the keywords may read:

http://cdn.startapp.com/creatives/android/full_screen/US/en_US/Ma
le/wifi/

and there may be N contents (e.g., advertisements) in this base CDN location. The SDK may draw a number (e.g., x<=N) according to the PDFunc provided by the content generator server 203. Consequently, the SDK may concatenate the drawn number (e.g., x if that is the same as the file name) to the above CDN location pointer to construct a URL providing a path to the selected content files located at CDN server 204n, and generate a content request using the URL for the content files, e.g., 210. The content files and their corresponding contents may exist at a location associated with or identified by the constructed CDN location pointer (e.g., URL address), and the CDN server 204 may provide the requested content to the user device, e.g., 214, after matching the received CDN location pointer to one existing at the CDN server (HTML pointer file initially provided by the content generator server 203). For example, the content files may be located in the same folder as the pre-existing HTML pointer file provided by the content generator server 203, or in general, the pre-existing file may provide directions to the location of the content files. In some instances, the requested file and the corresponding content may in fact not exist, e.g., at 211, and in such instances, the CDN server 204 may request for the pointer files and their contents from the content generator server, e.g., 212. Upon receiving the request, e.g., 213, the content generator server 203 may choose a relevant content (e.g., the associated pointer files and the contents) and return those to the user device 202 and/or the requesting CDN server 204, which in turn transmits the received files and contents to the user device 202. Further, the CDN server 204 stores the received files and contents at a location associated with the constructed CDN location pointer for future requests. The SDK in turn displays the received contents (e.g., ads) at the user device 202, e.g., 215. In some embodiments, the SDK may communicate with the content generator server 203 periodically to update data that has been retrieved during the session.

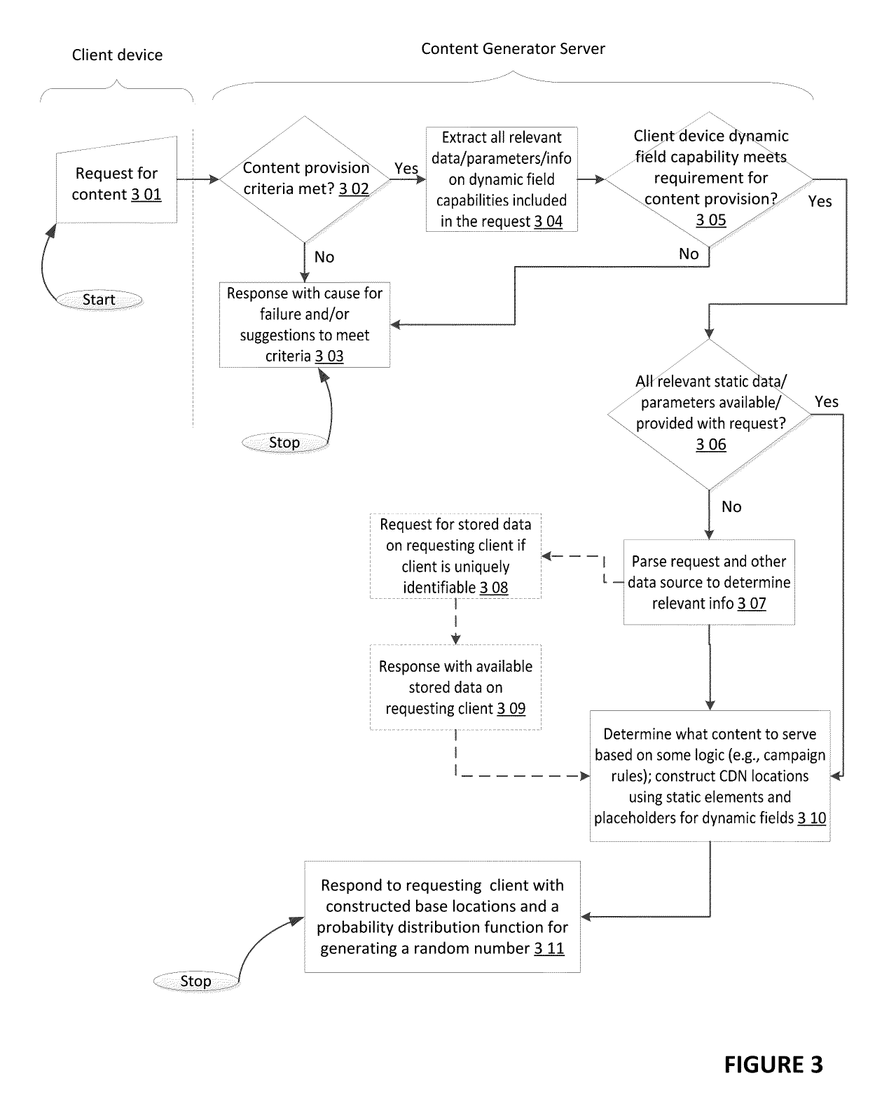

FIG. 3 is an example logic flow illustrating aspects of determining at a content generator server 203 content location pointers, in one embodiment. As shown in FIG. 3, a user device may transmit to a content generator server a content request for desired content files, e.g., at 301. The content generator server may determine if the criteria for provisioning the content are fulfilled by the request, e.g., at 302. An example of such criteria may be that the request includes a minimum amount of and/or specified data related to the user device, the device user, etc. If any of the criteria for providing the requested content is not met, the content generator server may inform the SDK of the user device of the failure to meet the criteria, optionally along with the cause of the failure and/or suggestions on how to meet the requirements, e.g., at 303. If all the criteria are fulfilled, the content generator server may then extract the user and/or device data and/or parameters, and information on the dynamic field capabilities of the SDK from the request, e.g., at 304. The relevant data/parameters may be static elements such as device characteristics, user information, etc., and/or they can be dynamic elements such as location of device/user, network connection type, atmospheric/environmental variables, etc. In some embodiments, the relevant data/parameters can be treated as both static and dynamic elements simultaneously. In choosing the contents to be provisioned to the user device 202, the content generator server may optionally perform several computations and/or apply some logic that may be based on predetermined criteria (e.g., ad campaign rules). The content generator server may check if the SDK at the user device is capable of properly handling any content that may be provided by the content generator server, e.g., at 305. For example, the content generator server may check if the SDK comprises macros that allow for the proper realization of dynamic fields in the CDN location pointers. If, in some instances, the content generator server determines that the SDK is not capable, the content generator server may inform the SDK of the failure to exhibit the capability, optionally along with the cause of the failure and/or suggestions on how to meet the requirements, e.g., at 303, or provide the content in a format that the content requesting device 202 is capable of handling.

Upon determining that the SDK comprises the dynamic field capability, in some instances, the content generator server may determine if all the data needed to construct a base CDN location pointer are available, e.g., at 306. For example, the content generator server may verify if the user device is a returning requester. In such instances, if some data is missing, the content generator server may parse the request and all other available data sources for the relevant missing information, e.g., at 307. For example, if available, the content generator server may query a database for stored data on the requesting user and/or device, e.g., at 308, and receive a response if the user and/or device are uniquely identifiable and the information is available, e.g., at 309. Upon determining that all the data to be used for constructing CDN location pointers is available, in some instances, the content generator server may generate the pointers using the static elements and/or placeholders for the dynamic elements, e.g., at 310. The content generator server may proceed to provide the generated CDN location pointer to the requesting device, along with PDFuncs for generating random numbers that specify which contents are to be selected from a possible set of contents that may exist at the location specified by the location pointer, e.g., at 311.

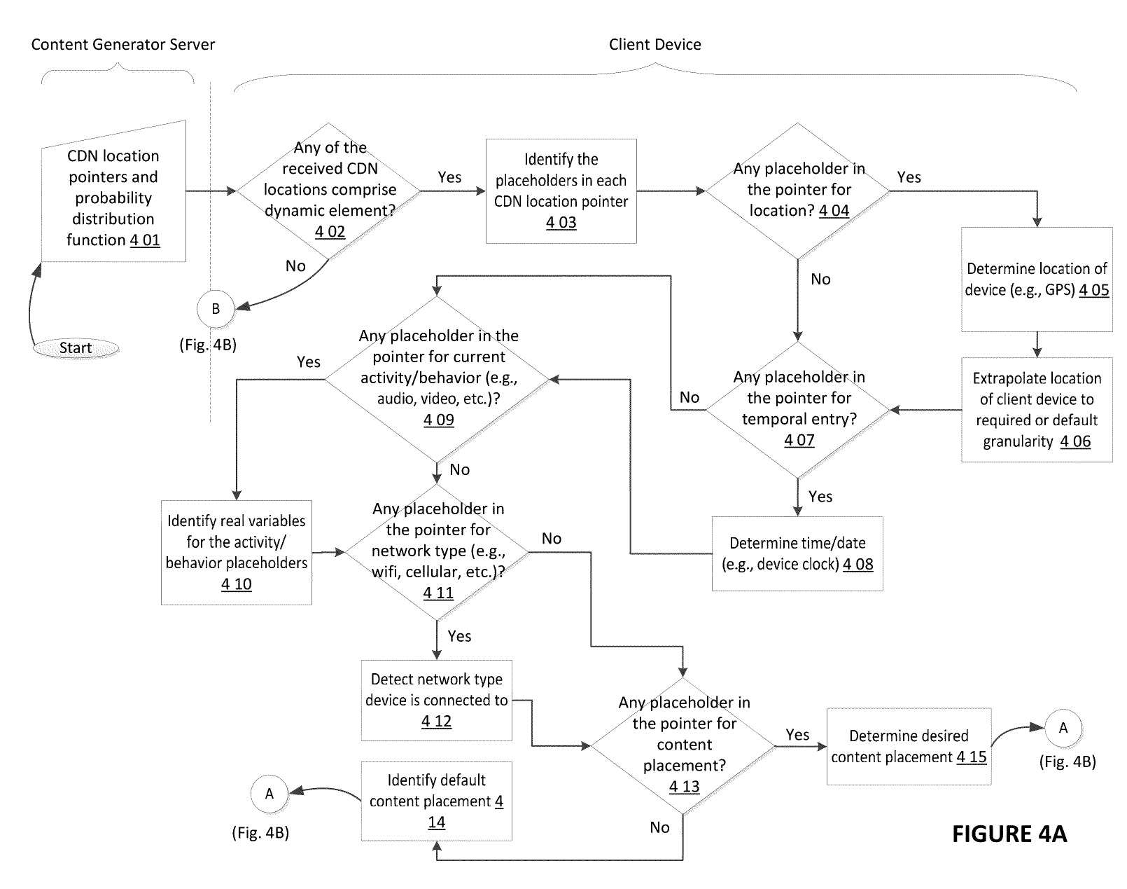

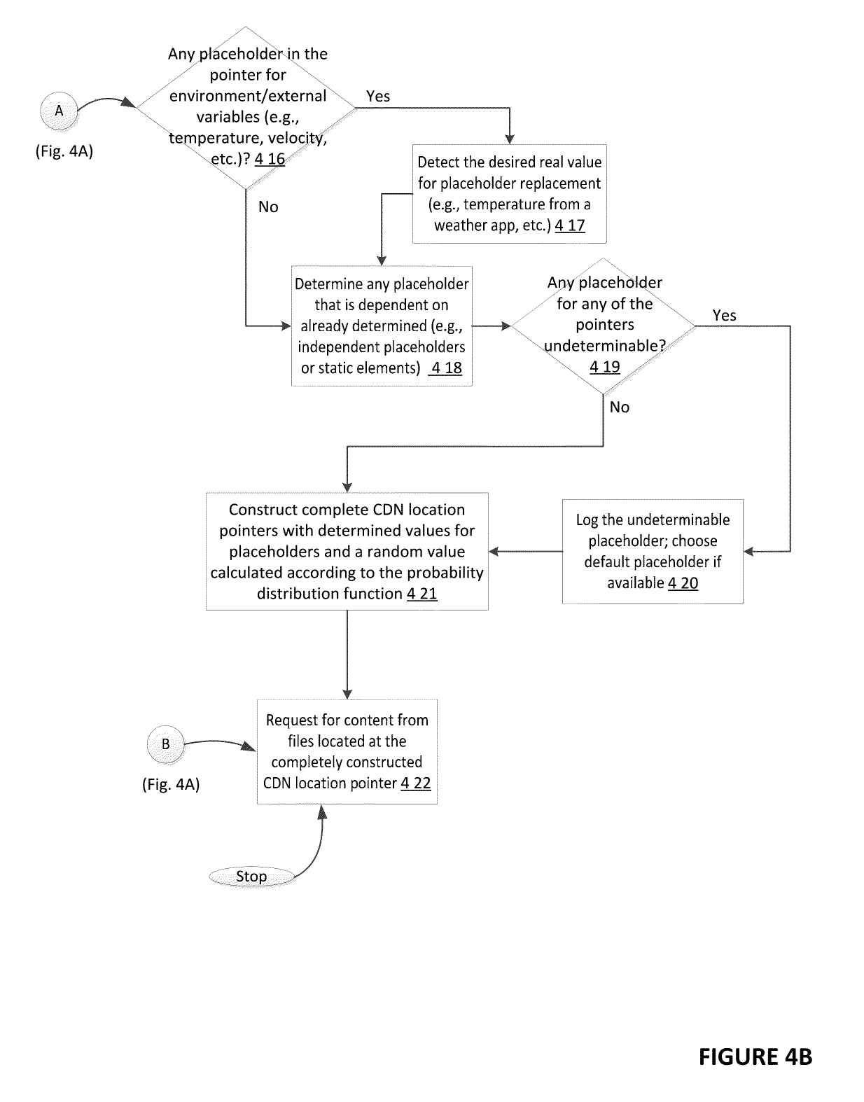

FIGS. 4A-B show an example logic flow illustrating aspects of determining at user device pointer files for content, in one embodiment. Upon receiving base CDN location pointers with PDFunc, e.g., 401, from the content generator server, the SDK at the user device may initially determine if any of the pointers comprise a dynamic element, i.e., the SDK may determine if there are any placeholders in the location pointers that are to be replaced with keywords, e.g., 402. If none of the location pointers comprises a dynamic element (e.g., they contain only static elements), the user device may proceed to generating a content request using the CDN pointers and sending such a request to the respective CDNs, as will be described below. In some instances, the location pointers may comprise dynamic elements, and the SDK may proceed to identifying the placeholders and the keywords to replace the placeholders with, e.g., at 403. In some instances, the SDK may manipulate the keywords that replace the placeholders, non-limiting examples of such manipulations being trimming, formatting, transforming, encoding, and/or the like. As an example of the SDK determining the keywords for placeholders, the SDK may verify if any of the placeholders are for a physical location of the device/user, e.g., 404, which the SDK may then extract from the device's location functionalities (e.g., GPS, cellular, WiFi triangulation, and/or the like), e.g., 405. The physical location may be obtained in various formats and/or precision, which, in some instances may not be the desired formats and/or precision. For example, the retrieved location may be in the form of a geographic coordinate specifying the approximate latitude and longitude of the location of the user device. However, in this example, the desired actual location value to replace the placeholder may simply be an identifier of a neighborhood, a city, a county, etc., and the SDK may then extrapolate from the retrieved location to obtain a physical location of the desired granularity (in some instances, a default granularity; as in the case when the desired granularity is not specified), e.g., at 406.

Further, the SDK may also establish if a placeholder for a temporal variable exists in any of the location pointers, e.g., at 407, and if so may consult, for example, the clock capabilities of the user device to acquire the temporal information, such as the time and/or date, e.g., at 408. In some instances, the SDK may optionally translate the obtained temporal information into a desired format. For example, the desired temporal data may be the quarter of the year, and from the current time and date provided by the clock, the SDK may extract the quarter (e.g., 9:35 am, Sep. 24, 2024 translates as 3^{rd} quarter of the year).

In some instances, the SDK may determine if some or all of the pointers have placeholders for the current activity and/or behavior of the device and/or device user, e.g., at 409. For example, the user may be engaging some functionality of the application whose session instigated the request for the contents from the content generator server. Non-limiting examples of such functionalities may be tapping and/or swiping to take pictures/videos, listening to audio, etc.). The SDK may monitor the activities of the user/device and identify the keywords for the activity/behavior placeholders, e.g., 410 (e.g., if the user has swiped five times, one type of content may be served; if the user has swiped fifty times, a different one may be displayed).

Another dynamic variable the SDK may check for placeholders in the location pointers is the network type to which the user device is connected. In some instances, the network type the device is connected to may determine the type and/or amount of content that may be displayed. For example, the SDK may determine the type of network by interrogating the user device's networking module, e.g., at 411 (e.g., connectivityManager.getActiveNetworkInfo( ) type request) to detect the network type, e.g., at 412. If, for example, the network type is cellular, the content served may not be as feature rich as it would be for a Wi-Fi™ network.

In some embodiments, the content to be displayed may be presented in different formats and arrangements. If the SDK determines there may not be any placeholders for a content placement in the location pointers, e.g., at 413, the SDK can place the content in a default position, e.g., at 414. However, in some instances, if a CDN location pointer has a placeholder for content placement, the SDK can determine a placement for the content in the device display, e.g., at 415. For example, the content may be displayed as a banner, full screen, application wall, etc., and the presentation may be timed and/or involve user interaction.

In some embodiments, the content to be displayed to the user may depend on environmental and/or external factors, and some or all of the CDN location pointers may have placeholders for such variables. For example, whether to deliver a content for an ice cream product or a hot chocolate product may depend on the outside temperature, and the CDN location pointer may have a placeholder for such a dynamic element (e.g., temperature). As such the SDK may determine if there are any placeholders in the CDN location pointers for environmental/atmospheric/external dynamic elements, e.g., at 416, and determine the keywords for such placeholders e.g., at 417. For example, the SDK may interrogate a weather app in the user device for the current temperature. In some embodiments, the user device may have a temperature sensing capability, and the SDK may extract the temperature from the user device. In some embodiments, the device may have an app executing on it that is capable of providing the data to the SDK to be utilized for replacing the placeholder.

In some embodiments, the determination of some placeholders may depend on the nature of other static or dynamic elements. For example, the placement of a content may depend on a static element such as user device type (e.g., whether the placement is a banner or full screen may depend on the size of the user device screen). As another example, the determination of a placeholder for a dynamic element may depend on another dynamic variable (e.g., choosing a media rich ad content or text based one may depend on whether the network type is Wi-Fi™ or cellular). As such, in all the placeholder determinations discussed above, the SDK may make the determinations based on the evaluations of the static and/or already determined dynamic elements, e.g., at 418.

In some embodiments, there may be placeholders in the CDN location pointers that the SDK may not be able to determine their keyword replacements and/or correct keyword replacements, e.g., at 419. For example, a faulty GPS may provide an erroneous physical location, or it may not be responsive to the interrogation of the SDK at all. In such embodiments, the SDK may log the failure and replace the placeholder with a default variable for the type of dynamic value (e.g., for location, it can be the last known value, or a definite value such as “US”), e.g., at 420.

Upon replacing all the placeholders in the CDN location pointers with their keywords and/or default values, in some embodiments, the SDK may construct completed pointers by drawing a random number based on PDFuncs obtained from the content generator server as described above and concatenating the number to the CDN location pointers comprising the static and dynamic elements, e.g., at 421. The SDK then may forward the CDN location pointer files to the CDN server to request the contents residing at the location pointer, e.g., at 422. Upon receiving the CDN location pointer file, in some embodiments, the CDN server may search for a matching pointer file and retrieve and provide the retrieved contents to the requesting device.

In some embodiments of the invention disclosed herein, a processor implemented method of generating content delivery network (CDN) location pointers is presented. Such a method may comprise: receiving, from an application at a user device, an ad content request including data on user, the user device and/or capabilities of a software development kit integrated in the requesting application at the user device. Static and/or dynamic elements from at least the received data may be retrieved, and in part based on the retrieved static elements, ad content to be served to the requesting application may be determined via a computer according to ad campaign rules. In some instances, ad content CDN location pointers to location of the determined ad content may be constructed using the retrieved static elements and/or placeholders for the retrieved dynamic elements. The constructed ad content CDN location pointer may be provided to the requesting application.

In the above embodiments, the data on the user may comprise demographics, device usage behavior and preferences, the data on the user device may comprise device type, device model, and operating system of the user device, and the capabilities of the software development kit may comprise trimming, formatting, transforming and encoding. Further, in some instances, retrieving static elements may comprise at least one of extracting the static elements from the received ad content request and receiving the static elements extracted by the software development kit.

In some instances, the method further comprises providing a probability density function for each CDN location pointer configured to select a natural number between zero and maximum number of ad contents located at the CDN pointer location.

In order to address various issues and advance the art, the entirety of this application shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of an individual and/or enterprise user, database configuration and/or relational model, data type, data transmission and/or network framework, syntax structure, and/or the like, may be implemented that enable a great deal of flexibility and customization as described herein.

What is claimed is:

1. A method, comprising:
defining a first pointer file containing a first location identifier for a content located at a Content Delivery Network (CDN) server so as to cause placement of the first pointer file at the CDN server;
receiving, from a requesting device, a request for the content, the request including data on at least one of the requesting device or a user of the requesting device;
constructing a second location identifier containing at least one element derived from the data; and
sending a second pointer file containing the second location identifier to the requesting device,
the second location identifier matching the first location identifier when a software development kit (SDK) executing on the requesting device defines the at least one element.

2. The method of claim 1, wherein the CDN server is from a plurality of CDN servers, and the first pointer file and the content are configured to be replicated for placement at each of the plurality of CDN servers.

3. The method of claim 1, wherein the content includes one or more of images, videos, and audios.

4. The method of claim 1, wherein the content includes formatting files.

5. The method of claim 1, wherein the content includes formatting files, and the formatting files having cascading style sheets (CSS) files and/or java script files.

6. The method of claim 1, wherein the first pointer file and the second pointer file include a file containing an HTML tag.

7. The method of claim 1, wherein the data includes device information having device type, device model, device display size, network the requesting device is connected to, and movement of the requesting device.

8. The method of claim 1, wherein the data includes information on user gender, user age, user income level, user recreational activities, and user social status.

9. The method of claim 1, wherein the data includes information on device location, time and weather conditions at location of the requesting device.

10. The method of claim 1, wherein the CDN server is from a plurality of CDN servers, and the CDN server has minimal latency to the requesting device compared to any of the plurality of CDN servers.

11. The method of claim 1, wherein the second location identifier provides a path to the CDN server.

12. The method of claim 1, wherein the at least one element is a static element.

13. The method of claim 1, wherein the at least one element is a static element, and the static element represents one or more of user gender, user age, requesting device type, and requesting device location.

14. The method of claim 1, wherein the at least one element is a dynamic element configured to be determined by the SDK executing on the requesting device.

15. The method of claim 1, wherein the at least one element is a dynamic element configured to be determined by the SDK executing on the requesting device, and
the dynamic element represents one or more of requesting device location or application activity at the requesting device.

16. The method of claim 1, wherein the at least one element is a dynamic element representing content placement on a display of the requesting device.

17. The method of claim 1, wherein the at least one element is a dynamic element representing content placement on a display of the requesting device, and the placement on the display of the requesting device includes banner placement, full screen placement, and application wall placement.

18. The method of claim 1, wherein the at least one element is a dynamic element derived from physical location information of the data, the dynamic element represented in the second location identifier by a physical location placeholder.

19. The method of claim 1, wherein:
the at least one element is a dynamic element derived from physical location information of the data, the dynamic element represented in the second location identifier by a physical location placeholder, and
the SDK determines the at least one element by interrogating a GPS module of the requesting device for a physical location of the requesting device.

20. The method of claim 1, wherein the at least one element is a dynamic element derived from information in the data on a network type the requesting device is connected to, the dynamic element represented in the second location identifier by a network type placeholder.

21. The method of claim 1, wherein:
the at least one element is a dynamic element derived from information in the data on a network type the requesting device is connected to, the dynamic element represented in the second location identifier by a network type placeholder, and
the SDK determines the at least one element by interrogating a networking module of the requesting device for the network type the requesting device is connected to.

22. The method of claim 1, further comprising defining a probability distribution function to generate a random number, the random number to be concatenated to the second location identifier by the SDK.

23. The method of claim 1, further comprising defining a probability distribution function to generate a random number, a maximum quantity of random numbers to be generated by the probability distribution function being equal to or less than a number of content available at a location identified by the second location identifier.

24. A method, comprising:
receiving, from a requesting device, a request for a content, the request including data on at least one of the requesting device or a user of the requesting device;
determining a location of a Content Delivery Network (CDN) server, the CDN being one of a plurality of CDN servers and having minimal latency to the requesting device compared to any of the plurality of CDN servers;
constructing a location identifier representing a path to the first CDN server and at least one placeholder for a dynamic element derived from the data;
sending a pointer file containing the location identifier to the requesting device; and
defining a probability distribution function configured to generate a random number to be concatenated to the location identifier;
the content residing at the location identified by the location identifier upon concatenation of the random number to the location identifier.

25. A non-transitory computer readable medium, the medium storing instructions configured to:
transmit to a content generating server a request for a content, the request including data on at least one of a requesting device or a user of the requesting device;
receive, as a response to the request, a first pointer file containing a first location identifier having at least one placeholder for a dynamic element derived from the data;
determine the dynamic element contained in the first location identifier;
replace the at least one placeholder in the first location identifier by the determined dynamic element so as to define a second location identifier; and
send to a CDN server a second pointer file containing the second location identifier, the CDN server being one of a plurality of CDN servers and having minimal latency to the requesting device compared to any of the plurality of CDN servers.
